(19) United States
(12) Patent Application Publication
(10) Pub. No.: US 2024/0184972 A1
(43) Pub. Date: Jun. 6, 2024

(54) ELECTRONIC DEVICE FOR PROVIDING CALENDAR UI DISPLAYING IMAGE AND CONTROL METHOD THEREOF

(71) Applicant: SAMSUNG ELECTRONICS CO., LTD., Suwon-si (KR)

(72) Inventors: Kyohee LEE, Suwon-si (KR); Sunhye KIM, Suwon-si (KR); Gahee LEE, Suwon-si (KR); Jiyoun HAN, Suwon-si (KR)

(73) Assignee: SAMSUNG ELECTRONICS CO., LTD., Suwon-si (KR)

(21) Appl. No.: 18/392,742

(22) Filed: Dec. 21, 2023

Related U.S. Application Data
(63) Continuation of application No. PCT/KR2023/016282, filed on Oct. 19, 2023.

(30) Foreign Application Priority Data
Dec. 6, 2022 (KR) 10-2022-0168742

(51) Int. Cl. G06F 40/106; G06F 3/04842; G06F 3/04845; G06F 3/04886

(52) U.S. Cl. CPC G06F 40/106; G06F 3/04842; G06F 3/04845; G06F 3/04886; G06F 2203/04803

(57) ABSTRACT

An electronic device for providing a calendar user interface (UI) displaying image and a control method thereof are provided. The electronic device may include a display, a memory configured to store a plurality of images, and a processor configured to control the calendar UI to display, in a date area of the calendar UI, a first image having time information corresponding to the date area, among a plurality of images, and based on the first image being selected among the plurality of images, identify a context included in the first image, search for a second image that is different from the first image and corresponds to the identified context, and control the calendar UI to display the second image together with the first image on the calendar UI.

### CROSS-REFERENCE TO RELATED APPLICATION(S)

This application is a bypass continuation of International Application No. PCT/KR2023/016282, filed on Oct. 19, 2023, which is based on and claims priority to Korean Patent Application No. 10-2022-0168742, filed on Dec. 6, 2022, in the Korean Intellectual Property Office, the disclosures of which are incorporated by reference herein in their entireties.

### BACKGROUND

### 1. Field

Apparatuses and methods consistent with the disclosure relates to an electronic device and a control method thereof, and more particularly, to an electronic device for generating a calendar UI displaying an image acquired by a user and a control method thereof.

### 2. Description of Related Art

With the development of communication technology and electronic device user interfaces, users may easily receive necessary information anytime and anywhere through an electronic device. For example, a user may receive real-time traffic information or weather information from an electronic device.

However, most of the information provided from the electronic device may require user-initiated commands (e.g., a voice command, etc.) related to the desired information. Accordingly, it is difficult for a user to receive an image or the like (e.g., a photo, a captured image, etc.) stored in advance in an electronic device. For example, in order for a user to receive a photo acquired and stored through an electronic device, the user has to search for a photo using criteria such as a date when the photo was taken, a title that the user inputs, and a location where the photo was taken, and the like. This is possible only if a user remembers pertinent details (date, title, location, etc.) for each photo. Alternatively, users may be required to set a separate index to search for a specific photo.

In particular, when a user acquires a plurality of images related to a specific subject at different times and stores the acquired images in an electronic device, the user should search for each image for the relevant subject. This takes a long time to search for images, and even if search results are acquired, missing images may occur. As a result, the purpose of storing each image fades, leading to a problem of reducing the usability of the image. To this end, whenever a user stores an image, a separate task of performing grouping with pre-stored images should be performed according to the purpose or subject of an image. This task also takes a long time, and has to be repeated, causing inconvenience to a user.

### SUMMARY

The disclosure provides an electronic device for providing a calendar UI displaying an image and a control method thereof.

According to an aspect of the present disclosure, an electronic device may include: a memory configured to store one or more instructions: and a processor configured to: control a calendar user interface (UI) to display, in a date area of the calendar UI, a first image having time information corresponding to the date area, among a plurality of images, and based on the first image being selected among the plurality of images, identify a context included in the first image, search for a second image that is different from the first image and corresponds to the identified context, and control the calendar UI to display the second image together with the first image on the calendar UI.

The processor may be further configured to search for the second image having the identified context within a preset date range based on a date corresponding to the first image.

The processor may be further configured to identify the context corresponding to a user schedule, among a plurality of contexts included in the first image, and search for the second image having the identified context.

The processor may be further configured to select the second image among the plurality of images, based on user preference that is set for each of the plurality of images.

Based on two or more images having the time information corresponding to the date area being selected among the plurality of images, the processor may be further configured to select one of the two or more images as the first image, based on the user preference.

The processor may be further configured to control the calendar UI to display the first image as a thumbnail image of the first image in the date area of the calendar UI.

Based on the thumbnail image being selected from the calendar UI, the processor may be further configured to control the calendar UI to display a pop-up window having at least one of a first area displaying the first image, a second area displaying the context included in the first image, a third area displaying the searched other images, and a fourth area displaying remaining images other than the first image from among the plurality of images.

The processor may be further configured to determine an arrangement position of each of the other images in the third area based on user preference set for each of the other images.

The electronic device may include a display configured to receive a touch input, wherein the user preference may be set based on a time duration of the touch input on each of the plurality of images.

The processor may be further configured to: identify an object included in the first image, and identify a context of the object as the context of the first image.

The processor may be further configured to: identify a plurality of objects included in the first image, select an object from among the plurality of objects based on user preference, identify the context of the first object as the context of the first image.

According to another aspect of the present disclosure, a method of controlling an electronic device, may include: controlling a calendar user interface (UI) to display, in a date area of the calendar UI, a first image having time information corresponding to the date area, among a plurality of images: based on the first image being selected among the plurality of images, identifying a context included in the first image: searching for a second image that is different from the first image and corresponds to the identified context: and displaying the first image and the second image together on the calendar UI.

The searching for the second image may include: searching for the second image within a preset date range based on a date corresponding to the selected image.

The method may further include: identifying the context corresponding to a user schedule, among a plurality of contexts included in the first image, and searching for the second image having the identified context.

The method may further include: selecting the second image among the plurality of images, based on user preference that is set for each of the plurality of images.

The method may further include: based on two or more images having the time information corresponding to the date area being selected among the plurality of images, selecting one of the two or more images as the first image, based on the user preference.

The controlling of the calendar UI may include: controlling the calendar UI to display the first image as a thumbnail image of the first image in the date area of the calendar UI.

According to another aspect of the present disclosure, there is provided a non-transitory computer-readable storage medium storing a program that when executed by a processor, performs a method of controlling an electronic device. The method may include: controlling a calendar user interface (UI) to display, in a date area of the calendar UI, a first image having time information corresponding to the date area, among a plurality of images: based on the first image being selected among the plurality of images, identifying a context included in the first image; searching for a second image that is different from the first image and corresponds to the identified context: and displaying the first image and the second image together on the calendar UI.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is an exemplary diagram illustrating a method of providing a UI calendar displaying an image according to an embodiment of the disclosure;

FIG. 2 is a schematic configuration diagram of an electronic device according to an embodiment of the disclosure;

FIG. 3 is an exemplary diagram illustrating displaying a plurality of images on a calendar UI according to an embodiment of the disclosure:

FIG. 4 is an exemplary diagram illustrating a method of checking a context included in a selected image and searching for another image having a context corresponding to the checked context, according to an embodiment of the disclosure:

FIG. 5 is an exemplary diagram illustrating a method of searching for a related image in a context corresponding to a user schedule, according to an embodiment of the disclosure:

FIG. 6 is an exemplary diagram illustrating displaying a selected image and a related image together on a calendar UI according to an embodiment of the disclosure:

FIG. 7 is an exemplary diagram illustrating a method of selecting one image from among a plurality of images acquired on the same date according to an embodiment of the disclosure:

FIG. 8 is an exemplary diagram illustrating a method of selecting one image from among a plurality of images having the same user preference according to an embodiment of the disclosure:

FIG. 9 is an exemplary diagram for describing a method of setting user preference for an image according to an embodiment of the disclosure:

FIG. 10 is an exemplary diagram of a pop-up window displayed when a thumbnail image is selected according to an embodiment of the disclosure;

FIG. 11 is an exemplary diagram illustrating identification of a context of an object included in a selected image according to an embodiment of the disclosure:

FIG. 12 is an exemplary diagram illustrating setting user preference to an object included in an image according to an embodiment of the disclosure:

FIG. 13 is an exemplary diagram illustrating acquiring an image having a context corresponding to a user schedule according to an embodiment of the disclosure;

FIG. 14 is an exemplary diagram illustrating displaying an image having a context corresponding to a user schedule according to an embodiment of the disclosure:

FIG. 15 is a detailed configuration diagram of an electronic device according to an embodiment of the disclosure:

FIG. 16 is a flow chart illustrating a method of controlling an electronic device according to an embodiment of the disclosure;

FIG. 17 is a schematic flowchart of a method of controlling an electronic device that searches for a related image based on context information, according to an embodiment of the disclosure; and

FIG. 18 is a schematic flowchart of a method of controlling an electronic device that searches for a related image based on context information of an object included in a selected image, according to an embodiment of the disclosure.

### DETAILED DESCRIPTION

General terms that are currently widely used were selected as terms used in embodiments of the disclosure in consideration of functions in the disclosure, but may be changed depending on the intention of those skilled in the art or a judicial precedent, the emergence of a new technique, and the like. In addition, in a specific case, terms arbitrarily chosen by an applicant may exist. In this case, the meaning of such terms will be mentioned in detail in a corresponding description portion of the disclosure. Therefore, the terms used in the disclosure should be defined on the basis of the meaning of the terms and the contents throughout the disclosure rather than simple names of the terms.

In the disclosure, an expression “have,” “may have,” “include,” “may include,” or the like, indicates existence of a corresponding feature (for example, a numerical value, a function, an operation, a component such as a part, or the like), and does not exclude existence of an additional feature.

An expression “at least one of A and/or B” is to be understood to represent “A” or “B” or “any one of A and B.”

Expressions “first,” “second,” “1st” or “2nd” or the like, used in the disclosure may indicate various components regardless of a sequence and/or importance of the components, will be used only in order to distinguish one component from the other components, and do not limit the corresponding components.

Singular forms are intended to include plural forms unless the context clearly indicates otherwise. It should be understood that terms “include” or “comprise” used in the present specification, specify the presence of features, numerals, steps, operations, components, parts mentioned in the present specification, or combinations thereof, but do not preclude the presence or addition of one or more other features, numerals, steps, operations, components, parts, or combinations thereof.

In the disclosure, the term user may refer to a person using an electronic device or a device (for example, an artificial intelligence electronic device) using the electronic device.

Hereinafter, various embodiments of the disclosure will be described in detail with reference to the accompanying drawings.

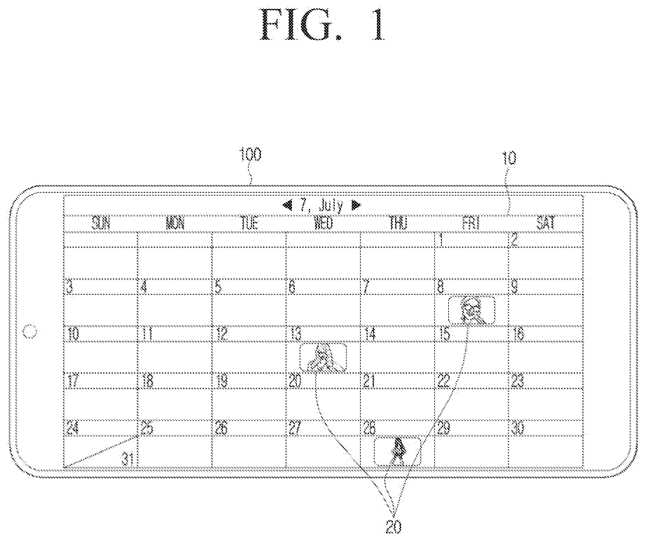

FIG. 1 is an exemplary diagram illustrating a method of providing a UI calendar displaying an image according to an embodiment of the disclosure.

Referring to FIG. 1, an electronic device according to an embodiment of the disclosure may display a calendar UI on which an image is displayed through a display.

According to an embodiment of the disclosure, images 20 may be displayed on the calendar UI 10 in an area corresponding to a date on which each of the images 20 is acquired. A user may check the images 20 through the calendar UI 10. The images 20 may be referred to as retrieval target images, which the user intends to search for and retrieve from a local or external memory storage.

Conventionally, in order for a user to search for or check an image stored in an electronic device 100, a user had to search for an image in an application (e.g., a photo album or a photo folder) in which a plurality of images are stored. For example, a method in which a user searches for an image in a photo album folder through a scroll input or a touch input corresponds thereto. In this search method, it takes a long time for a user to search for a required image, and above all, it is difficult to properly demonstrate the purpose of the user who has stored the image.

For example, a user may store a plurality of images related to a specific item in an electronic device for reference when purchasing or using a specific item. In this case, a plurality of images may be stored in the electronic device 100 at different times. Accordingly, at the moment of purchasing a specific item, a user should search for each of the plurality of stored images in relation to a specific item. This takes a long time to search for each image, and sometimes results in missing some images in the search process. Accordingly, it leads to the result that the purpose of storing the image is not properly exhibited.

As a result, according to an embodiment of the disclosure, the electronic device 100 provides the UI 10 in the form of a calendar, and displays each image 20 in a date area in the calendar UI 10 corresponding to a date on which each image was acquired. This allows a user to receive the image 20 acquired by the user corresponding to each acquired date without a separate search process, since a thumbnail image of or a link to a retrieval target image is incorporated into the calendar UI 10. In particular, the electronic device 100 displays images related to each image 20 together based on the context of the image 20 displayed on the calendar UI 10, so the user may receive images related to each image 20 without the user's search process.

The electronic device 100 may be a client device or a server. When the electronic device 100 is a server, the server may receive a user instruction from a client device, via the calendar UI 10 installed on the client device, search for the image 120, and transmit information of the image 120 to the client device, so that the client device displays the image 120 itself, or a link to or a thumbnail image of the image 120, on the calendar UI 10.

Hereinafter, an embodiment of the disclosure related to this will be described in detail.

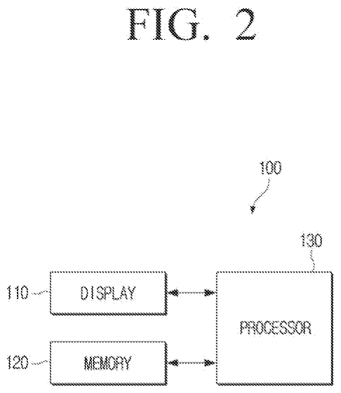

FIG. 2 is a schematic configuration diagram of an electronic device according to an embodiment of the disclosure.

The electronic device 100 according to an embodiment of the disclosure includes a display 110, a memory 120, and a processor 130.

The electronic device 100 according to the embodiment of the disclosure may provide a service of displaying images stored in the memory 120 on the calendar UI 10 and displaying related images by recognizing the context of each image. To this end, the electronic device 100 may be implemented in various electronic devices such as smart phones, tablet PCs, notebook PCs, desktop PCs, wearable devices such as a smart watch, electronic picture frames, humanoid robots, audio devices, and smart TVs.

The display 110 may display various types of information. Specifically, the display 110 displays the calendar UI 10 generated by the processor 130. Then, the plurality of images 20 are displayed on the calendar UI 10 displayed by the processor 130 in the date area where each image 20 is acquired. As at least one image 20 is selected from among the plurality of images 20 displayed on the calendar UI 10, the display 110 displays a related image to the selected image 20 or displays other images acquired on the same date as the selected image.

To this end, the display 110 may be implemented in various types of displays such as a liquid crystal display (LCD), a light emitting diode (LED), an organic light emitting diode (OLED) display, a liquid crystal on silicon (LCoS), digital light processing (DLP), and the like. In addition, a driving circuit, a backlight unit, and the like, that may be implemented in a form such as a-si TFT, low temperature poly silicon (LTPS) TFT, an organic TFT (OTFT), and the like, may be included in the display 110.

The memory 120 stores a plurality of images. Here, the plurality of images may include an image acquired through a camera included in the electronic device 100, an image acquired by capturing a web page or the like displayed on the display 110, or an image received from another user through a messenger, or the like. Also, the plurality of images may include an image of each frame constituting a video.

Meanwhile, the memory 120 may store an operating system (O/S) for driving the electronic device 100. In addition, the memory 120 may store various software programs or applications for operating the electronic device 100 according to various embodiments of the disclosure. For example, according to an embodiment of the disclosure, the memory 120 may store a neural network model trained to acquire a context for an object in an image, a neural network model trained to acquire a context for an image by analyzing an image, and a neural network model trained to recognize an object in an image.

In addition, the memory 120 may store various types of information such as various types of data input, set, or generated during execution of programs or applications. In addition, the memory 120 may include various software modules for operating the electronic device 100 according to various exemplary embodiments of the disclosure, and the processor 130 may execute the various software modules stored in the memory 120 to perform an operation of the electronic device 100 according to various exemplary embodiments of the disclosure. To this end, the memory 120 may include a semiconductor memory such as a flash memory, a magnetic storing medium such as a hard disk, or the like.

The processor 130 may be electrically connected to the display 100 and the memory 120 to control overall operations and functions of the electronic device 100.

In addition, according to an embodiment of the disclosure, the processor 130 may generate, in at least one of a plurality of date areas, the calendar UI 10 displaying the image 20 having time information corresponding to the date area among the plurality of images. The processor 130 may control the display 110 to display the generated calendar UI 10.

Here, the time information may include information indicating a time when each image is acquired or information indicating a time when each image was acquired and then stored in the memory 120. The processor 130 may identify time information of each image based on meta data of each image.

Images maybe acquired in a variety of ways. For example, the images may be acquired through the camera of the electronic device 100, acquired by capturing a web page or the like displayed on the display 110 according to a user's capture command, or received and acquired from an external server. The processor 130 may identify time information of each image based on meta data of each image acquired by various methods.

Also, the processor 130 may identify a date area where each image is displayed based on the identified time information. Specifically, the processor 130 may identify the date when each image is acquired based on the identified time information, and display each image 20 in an area corresponding to the acquired date within the calendar UI 10.

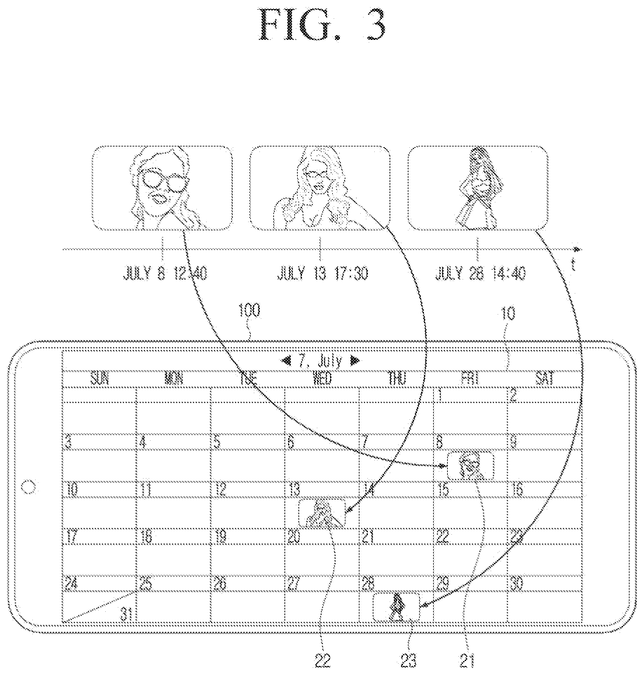

FIG. 3 is an exemplary diagram illustrating displaying a plurality of images on a calendar UI according to an embodiment of the disclosure.

The calendar UI 10 refers to a UI indicating user's schedule information. In FIG. 3, the calendar UI 10 shows the user's schedule information on a monthly basis, but according to embodiments, the calendar UI 10 may be displayed in various forms such as on daily, weekly, and yearly basis. Specifically, when the calendar UI 10 is displayed on a daily basis, the calendar UI 10 may include a plurality of time domains. In this case, the processor 130 may display, in each time domain, an image having time information corresponding to each time domain based on the time information of each image. However, hereinafter, for convenience of description of the disclosure, it will be described that the calendar UI 10 is generated on a monthly basis.

Meanwhile, the calendar UI 10 may be composed of a plurality of date areas. Here, the plurality of date areas may be fields in which information on each date is displayed. The “date area” may be also referred to as a “date cell” which is a space where the date is displayed, and where events, notes, and/or images for that specific date can be added. For example, according to an embodiment of the disclosure, an image acquired on a corresponding date may be displayed in the date area, and when a user schedule is set on a specific date by a user, a set user schedule may be displayed in a date area corresponding to a specific date.

Meanwhile, the processor 130 may generate a calendar UI 10 displaying each image 20 in a date area corresponding to each image.

Specifically, first, the processor 130 may generate the calendar UI 10 corresponding to a month selected by the user. In this case, the generated calendar UI 10 may include areas corresponding to a plurality of days (or dates) constituting the corresponding month. Meanwhile, the processor 130 may display each image 20 in a plurality of date areas constituting the generated calendar UI 10. Specifically, each image 20 may be displayed in a date area in the calendar UI 10 corresponding to the acquired date based on time information on each image 20.

Referring to FIG. 3, the processor 130 may first generate a calendar UI 10 and then display the generated calendar UI 10 through the display 110. FIG. 3 illustrates that the calendar UI 10 corresponding to July is generated and then displayed through the display 110. Also, the processor 130 may display the plurality of images 20 acquired in July in the date area corresponding to the date when each image is acquired. Specifically, the processor 130 may display an image 21 acquired at 12:40 on July 8 in an area corresponding to July 8 in the calendar UI 10, display an image 22 acquired at 17:30 on July 13 in an area corresponding to July 13 in the calendar UI 10, and display an image 23 acquired at 14:40 on July 28 in an area corresponding to July 28 in the calendar UI 10.

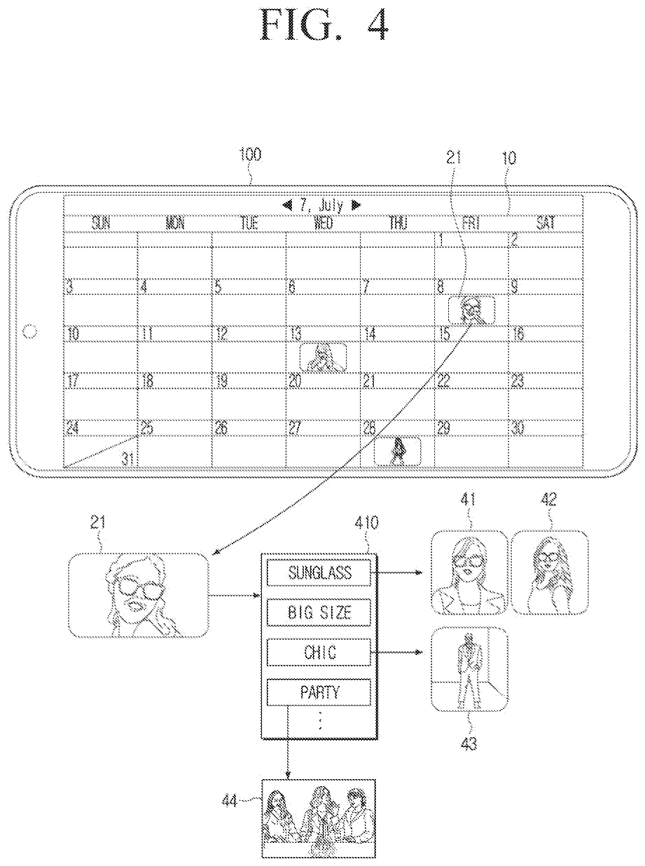

FIG. 4 is an exemplary diagram illustrating a method of checking a context included in a selected image and searching for another image having a context corresponding to the checked context, according to an embodiment of the disclosure.

According to an embodiment of the disclosure, when one of the images displayed on the calendar UI 10 is selected, the processor 130 checks a context included in the selected image, and searches for an image different from the selected image having a context corresponding to the checked context. The processor 130 controls the display 110 to display the searched other images together on the calendar UI 10.

First, while the calendar UI 10 is displayed through the display 110, the processor 130 may receive a user input for selecting one of the images displayed on the calendar UI 10. Specifically, the processor 130 may receive a user input for selecting one of the images displayed on the calendar UI 10 through an input interface. Alternatively, the processor 130 may detect a touch input for selecting one of the images displayed on the calendar UI 10 through the display 110.

Then, the processor 130 checks the context included in the selected image. Context information included in an image according to an embodiment of the disclosure may include information on objects, such as information on the type, color, and material of objects in the image. That is, the context information may be information acquired through analysis of the object itself included in the image. The context information may refer to details and relationships present within the image regarding the object, which help in understanding the object, such as a type, a color, a class, and a texture of the object.

Meanwhile, a neural network model learned to acquire context information on an object may be stored. A neural network model trained to acquire context information on an object may be a neural network model that is trained to output context information on objects included in each image with training data composed of a plurality of images including at least one object. For example, the neural network model trained to acquire context information on an object may be implemented as a convolutional neural network (CNN) model, a fully convolutional networks (FCN) model, a regions with convolutional neural networks features (RCNN) model, a you only look once (YOLO) model, etc.

In an embodiment of the present disclosure, a labeled dataset where each image is paired with relevant keywords or concepts is created. For instance, a training image with a person wearing sunglasses, a hat, and party decorations may be paired with corresponding keyword labels, such as “sunglasses” “hat,” and “party.” The neural network model may include a convolutional neural network configured to extract visual features from the training image, and a semantic extraction network configured to identify text features (e.g., key words) associated with the visual features. The neural network model may compute a loss based on a difference between the text features output from the neural network model, and the keyword labels (i.e., ground-truth text features). The neural network model may be trained until the loss reduces to a predetermined threshold, or the loss converges into a constant value with a predetermined margin. Once the neural network model is trained, the neural network model may be used in an inference stage to receive an image as an input, and output predicted one or more keywords associated with the image, as contact information of the input image.

Hereinafter, a neural network model trained to acquire context information on an object will be referred to as a first neural network model.

The processor 130 may acquire the context information on the selected image by inputting object information included in the image identified as selected according to the user input to the first neural network model. For example, the processor 130 may acquire context information on an object by inputting an image selected by a user to a first neural network model.

Alternatively, the processor 130 may acquire context information on an object by extracting the object information included in the image selected by the user and inputting the extracted object information to the first neural network model. In this case, the processor 130 may extract an image of an object as object information by cropping the image of the object included in the image, or may extract object information by identifying a type of objects through object recognition.

Meanwhile, the context information may include information such as an atmosphere of an image, a color of an image, and a type of background in an image. That is, the context information may include context information acquired through analysis of the image itself.

To this end, the memory 120 may store a neural network model trained to acquire context information on an image by analyzing the image. Specifically, the neural network model trained to acquire context information on an image by analyzing the image may be a neural network model trained to acquire context information on an image by analyzing each of the plurality of images with training data. The neural network model may have a same network structure or topology as the first neural network model, but may be trained using a different type of a labeled dataset from the first neural network model (e.g., keyword labels “joyful” and “pink color tone” which are paired with a training image) so that the neural network model may provide context information about the overall image (e.g., a background color and an atmosphere), rather than context information being limited to a specific object in the image. However, the network structure and the manner of training the neural network model are not limited thereto. For example, the neural network model trained to acquire context information by analyzing an image may be implemented as a convolutional neural network (CNN) model, a fully convolutional networks (FCN) model, a regions with convolutional neural networks features (RCNN) model, a YOLO model, etc. Hereinafter, a neural network model trained to acquire context information by analyzing an image will be referred to as a second neural network model.

Meanwhile, although the first neural network model and the second neural network model have been described as separate neural network models, the first neural network model and the second neural network model may be implemented as one neural network model. Specifically, context information on an object and context information on an image itself may be output by at least one first hidden layer for object analysis and at least one second hidden layer for image analysis among a plurality of hidden layers constituting one neural network model.

The processor 130 may acquire the context information of the selected image by inputting the image identified as selected according to the user input to the second neural network model.

For example, referring to FIG. 4, upon receiving a user input for selecting an image 21 displayed in a date area of July 8 in the calendar UI 10, the processor 130 may identify the context information of the selected image 21. The processor 130 identifies “sunglasses”, “big size”, “chic”, “party”, etc., as the context information of the selected image. Then, the processor 130 identifies contexts corresponding to each of the identified contexts, and acquires an image having or matching the identified context from the memory 120. In order to find matching images, the processor may compute a cosine similarity or an Euclidean distance between visual features extracted from each candidate image and each of the contexts, in a joint embedding space where visual features and text features are projected. The processor 130 acquires two matching images 41 and 42 as images having a context corresponding to “sunglasses” among a plurality of contexts of the selected image, and acquires one matching image 43 as an image having a context corresponding to “Chic” and one matching image 44 as an image having or matching a context corresponding to “Party” from the memory 120.

Meanwhile, the processor 130 may acquire context information on an image based on metadata of the image. The metadata may be incorporated into or affixed to the image, or may be provided separately from the image. Specifically, after identifying time, place, and the like where an image is acquired based on metadata, the context information on the image may be acquired by combining the identified time, place, and the like. For example, when the place where the image is acquired is “restaurant” and the time the image was acquired is “evening”, the processor 130 may acquire “restaurant” and “evening” as context information on an image, or acquire context information such as “propose”, “wine”, and “steak” by combining “restaurant” and “evening”. To this end, a table related to context information matched with meta data may be stored in the memory 120.

Meanwhile, context information on an image may be acquired in advance and then matched with the image and stored in the memory 120. That is, when an image is acquired or user preference for the acquired image is input, the processor 130 may acquire context information on an image, match the acquired context information with the image, and store the matched image in the memory 120.

The processor 130 checks the context information on the selected image, and then searches for an image different from the selected image having a context corresponding to the checked context.

Specifically, the processor 130 identifies context information corresponding to the checked context information. Here, the context information corresponding to the checked context information may be the same context information as the checked context information or related context information. For example, when the context information is “sunglasses”, context information corresponding to the context information may include “sunglasses”, “party”, “vacation”, and the like.

The processor 130 may identify context information corresponding to the checked context information by using a matching table for context information stored in the memory 120. That is, the processor 130 may identify context information corresponding to (or matching with) the context information of the selected image through the matching table about the context information.

The processor 130 may acquire an image having context information identified through the matching table. Specifically, as described above, context information of each image may be matched with each image and stored in the memory 120. Accordingly, the processor 130 may acquire at least one image matching the identified context information based on the context information identified through the matching table. Hereinafter, for convenience of description, other images searched based on the context of the selected image will be referred to as the selected image and related images.

In this case, according to an embodiment of the disclosure, the processor 130 may search for other images having or matching the checked context within a range of a preset period based on a time corresponding to the selected image.

First, the processor 130 may identify a date corresponding to the selected image. Specifically, the processor 130 may identify a date corresponding to a date area where the selected image is displayed. Alternatively, the date when the selected image was acquired may be identified based on the metadata of the selected image.

The processor 130 may search for an image (i.e., a related image or a matching image) having a context corresponding to the context of the selected image among images acquired within a preset date range based on the identified date. The processor 130 may acquire the searched related image from the memory 120. Meanwhile, the date range may be set in advance in various forms in units of time, days, and months.

For example, referring to FIG. 4, assuming that the preset date range is February, the processor 130 may acquire an image related to an image displayed in an area of July 8 selected by the user from among images acquired within two months as of July 8. Accordingly, the processor 130 may save time and resources required to acquire an image related to the selected image.

In this case, according to an embodiment of the disclosure, the processor 130 may search for an image different from the selected image having or matching a context corresponding to the checked context among other images having time information corresponding to an area on a date different from a date area in which the selected image is displayed. That is, the processor 130 may acquire an image acquired on a different date from the selected image as a related image of the selected image. Accordingly, a user may receive an image (i.e., a related image or a matching image) related to an image acquired on each date without searching for images acquired in the past.

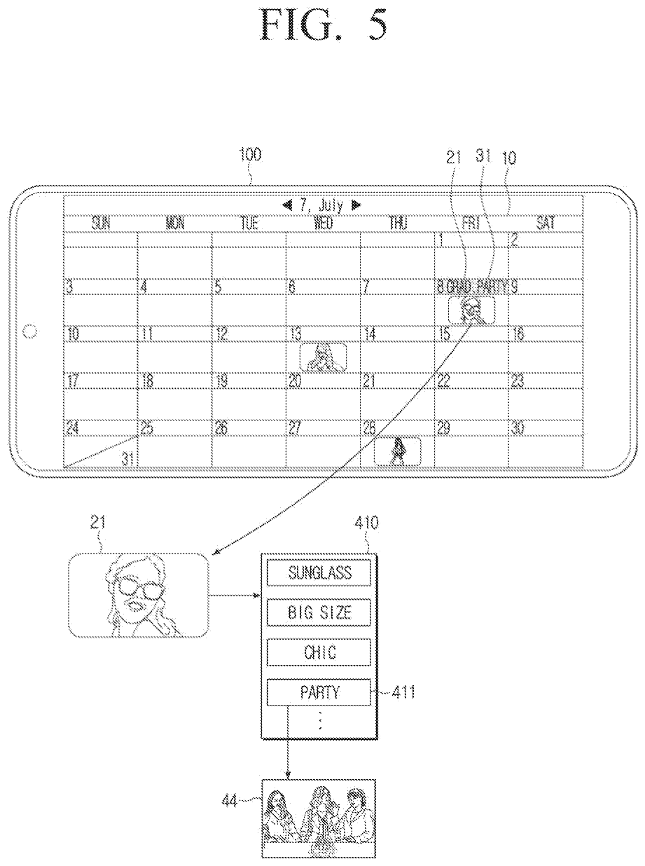

FIG. 5 is an exemplary diagram illustrating a method of searching for a related image in a context corresponding to a user schedule, according to an embodiment of the disclosure.

Meanwhile, according to an embodiment of the disclosure, the processor 130 may check a user schedule 31, check a context corresponding to the user schedule 31 among the contexts included in the selected image, and search for other images having a context corresponding to the checked context.

Specifically, the processor 130 may first identify whether there is a user schedule 31 set or input on a date corresponding to the date area where the selected image is displayed. For example, a user may set or input a user schedule 31 on a specific date through the calendar UI 10, and the user schedule 31 set by the user may be displayed in a date area corresponding to a specific date.

Accordingly, the processor 130 may identify whether the preset user schedule 31 exists on the date when the selected image is displayed. Further, the processor 130 may check a context corresponding to the user schedule 31 from among a plurality of contexts of the selected image. To this end, when the processor 130 identifies that the user schedule 31 exists, the processor 130 may identify context information on the user schedule 31. The context information on the user schedule 31 may be identified based on the place, time, type, event name (e.g., “graduation party”), and nature related to the user schedule 31. To this end, the processor 130 may analyze the text of the user schedule 31 and acquire the context information on the user schedule 31 based on the analysis result.

Meanwhile, the processor 130 may identify a context corresponding to a context related to the user schedule 31 from among the plurality of contexts of the selected image, and search for a related image based on the identified context. For example, referring to FIG. 5, when the image 21 displayed on July 8 is identified as being selected, the processor 130 determines the user schedule 31 set on July 8. In this case, the processor 130 may identify that a “graduation party” exists in the user schedule 31 set on July 8. Also, the processor 130 may identify a context related to the “graduation party” among the plurality of contexts (“sunglasses”, “big size”, “chic”, “part”, and the like) of the selected image. In this case, the processor 130 may identify the context of the “graduation party” and select a context corresponding to the identified context of the “graduation party” from among the plurality of contexts of the selected image. When the processor 130 identifies “Party” as a context corresponding to “Graduation Party”, the processor 130 may acquire an image 44 having a context corresponding to “Party” as a related image. That is, the processor 130 may identify only one image 44 as a related image of the image selected by the user (i.e., the image displayed in a date area of July 8).

In the case of the image displayed in the date area where the user schedule 31 is set, it may be an image acquired in relation to the set user schedule 31 or through the user schedule 31. Accordingly, the processor 130 selects a context for searching for a related image in consideration of the user schedule 31 among the plurality of contexts of the selected image, thereby identifying only a more relevant image as the related image.

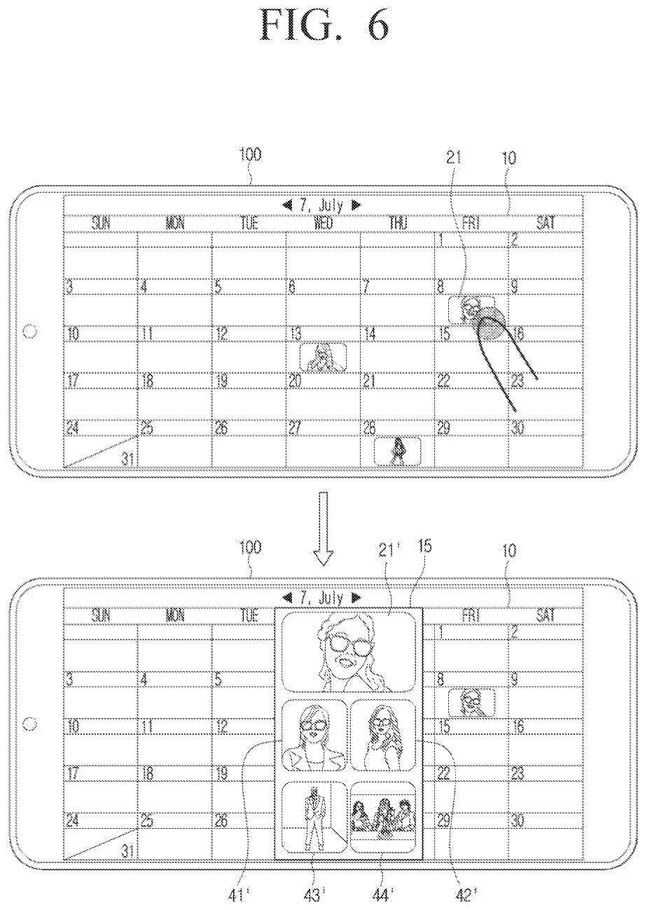

FIG. 6 is an exemplary diagram illustrating displaying a selected image and a related image together on a calendar UI according to an embodiment of the disclosure.

Meanwhile, the processor 130 controls the display 110 to display the searched other images together on the calendar UI 10.

Specifically, the processor 130 may control the display 110 to display the searched and identified related image together with the selected image on the calendar UI 10. To this end, the processor 130 may generate the pop-up window in which the related image and the image selected by the user are displayed together, and control the display 110 to display the generated pop-up window.

Referring to FIGS. 4 and 6, in FIG. 4, the processor 130 acquires four images 41, 42, 43, and 44 as images related to images displayed on the July 8 area selected by the user. Referring to FIG. 6, the processor 130 may generate the pop-up window 15 displaying four related images 41′, 42′, 43′, and 44′ acquired based on the image 21 selected by the user and the context. In this case, the processor 130 may display the selected image 21 on the pop-up window 15 in a first preset size, and may display the related images 41′, 42′, 43′, and 44 in a preset second size. In this case, the first size may be set to be larger than the second size.

Meanwhile, the image 21 selected by the user and the related image may be displayed in various ways, such as displaying through the entire screen of the display 110 or in the form of the web page, in addition to the pop-up window.

Meanwhile, according to an embodiment of the disclosure, the processor 130 may select the plurality of images 20 based on user preference set for each of the plurality of images 20 and generate the calendar UI 10 displaying an image having time information corresponding to the date area among the plurality of selected images 20.

Specifically, the processor 130 may select only an image for which the user preference is set from among the plurality of images 20 stored in the memory 120 and display the image on the calendar UI 10. Here, the image for which user preference is set refers to an image to which an input value indicating user preference is input by a user. The processor 130 may identify whether information indicating user preference is included in metadata of each image. When it is identified that information indicating user preference is included in the meta data, the processor 130 may identify that the user preference is set for the corresponding image.

As such, the processor 130 may select only an image including information corresponding to user preference among the plurality of images 20 and display only the selected image on the calendar UI 10.

Meanwhile, the user preference may be set in various forms. For example, even when a user acquires an image and then adds tagging information to the acquired image, it may be identified that the user preference is set for the acquired image. Alternatively, the user may input user preference for each acquired image through a separate UI.

Meanwhile, the user preference may be set for an image as a specific value indicating the degree of user preference. In this case, according to an embodiment of the disclosure, the processor 130 may select only an image having user preference equal to or greater than a preset value from among the plurality of images 20 for which the user preference is set. That is, an image to be displayed on the calendar UI 10 may be selected in consideration of not only whether the user preference is set, but also whether the user preference is equal to or greater than a preset value.

In this case, when the plurality of images 20 having time information corresponding to one date area are selected, the processor 130 selects one image from among the plurality of selected images 20 based on the user preference, and generates the calendar UI displaying the selected image.

Specifically, when the plurality of images 20 for which the user preference is set on the same date are selected, the processor 130 may identify user preferences set for each of the plurality of selected images 20. Then, the processor 130 may compare each identified user preference and select one image from among the plurality of selected images 20. In this case, according to an embodiment of the disclosure, the processor 130 may select an image having the highest user preference among the plurality of images 20. That is, an image having the highest user preference may be selected as a representative image corresponding to the corresponding date. Also, the processor 130 may display the selected image (i.e., representative image) in the date area corresponding to the plurality of images 20 in the calendar UI 10.

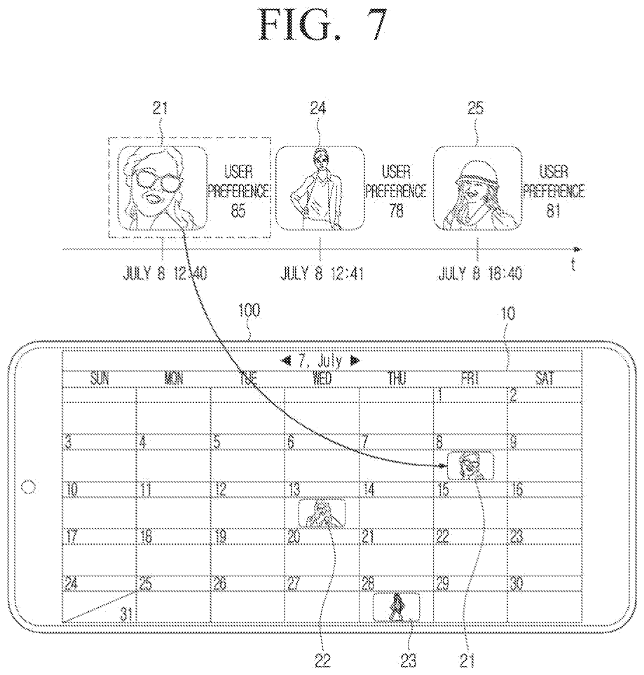

FIG. 7 is an exemplary diagram illustrating a method of selecting one image from among a plurality of images acquired on the same date according to an embodiment of the disclosure.

For example, FIG. 7 illustrates that three images were acquired on July 8. Specifically, three images acquired on July 8 include the image 21 acquired at 12:40, the image 24 acquired at 12:41, and the image 25 acquired at 18:40. In this case, the processor 130 may identify user preferences set for each of the three images 21, 24 and 25. According to FIG. 7, preference scores for the three images 21, 24, and 25 acquired on July 8 are 85, 78, and 81, respectively. The preference scores may be given based on user inputs, or analysis of user behavior. Accordingly, the processor 130 may select the image (i.e., the image 21 acquired at 12:40 on July 8) having the highest user preference. In addition, the processor 130 may display the image 21 for which the selected user preference is set the highest in the date area corresponding to July 8. That is, the processor 130 may select the image 21 acquired at 12:40 having the highest user preference of 85 among the plurality of images as the representative image of July 8.

Meanwhile, according to an embodiment of the disclosure, when there are the plurality of images having the highest user preference among the plurality of selected images, the processor 130 may select one image from among the plurality of images having the highest user preference based on the number of context information. Specifically, the processor 130 may select, as one image, an image having more context information from among the plurality of images having the highest user preference. The selected one image may be displayed in the date area corresponding to the plurality of images

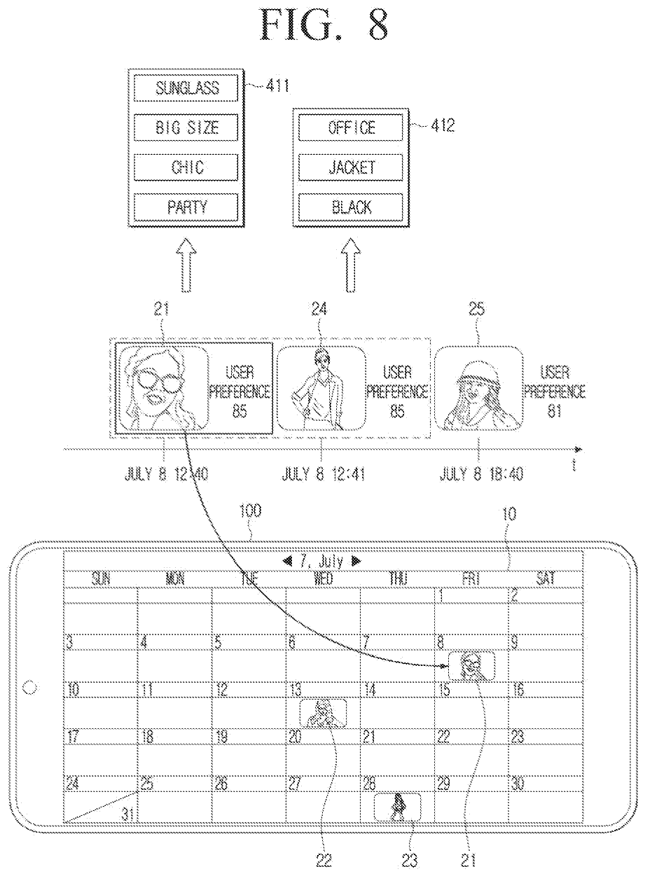

FIG. 8 is an exemplary diagram illustrating a method of selecting one image from among a plurality of images having the same user preference according to an embodiment of the disclosure.

Referring to FIG. 8, user preference scores for three images (image 21 acquired at 12:40, image 24 acquired at 12:41, and image 25 acquired at 18:40) acquired on July 8 are set to 85, 85 and 81, respectively. In this case, the processor 130 may identify two images 21 and 24 as the image having the highest user preference (i.e., the user preference is set to 85) among the plurality of images 21, 24, and 25. The processor may identify the context information of the identified two images 21 and 24, respectively. Referring to FIG. 8, the processor identified context information 411 of the image 21 acquired at 12:40 on July 8 as four, and context information 412 of the image 24 acquired at 12:41 on July 13 as three. The processor may select the image 21 acquired at 12:40 on July 8, which is the image having the largest number of context information among the plurality of images 21 and 24 for which the user preference is set to 85, as the representative image of July 8, and may be displayed in an area corresponding to July 8 in the calendar UI 10.

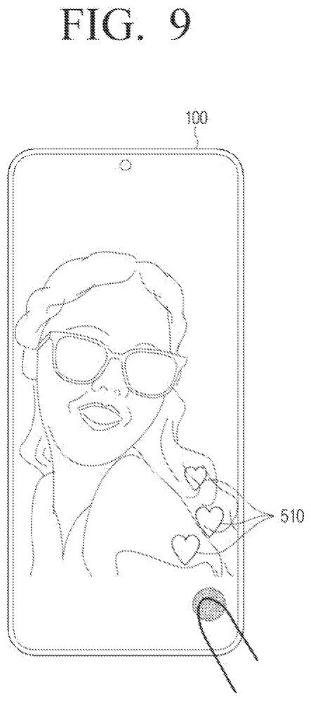

FIG. 9 is an exemplary diagram for describing a method of setting a user preference of an image according to an embodiment of the disclosure.

Meanwhile, the user preference may be set by a user touch input. That is, according to an embodiment of the disclosure, the processor 130 may set the user preferences for each image based on an input time of a touch input on each image detected through the display 110. To this end, the display 110 of the electronic device according to an embodiment of the disclosure may include a touch panel.

First, according to an embodiment of the disclosure, the display 110 may further include a touch panel. In this case, the display 110 may be implemented in an external type in which the touch panel in the form of a film is attached to the outside of the display panel or in a built-in type in which the touch panel is embedded in the display panel. The touch panel is implemented in a method of detecting a change in resistance of a touch recognition point or a method of detecting a change in capacitance according to an implementation method. As a result, the display 110 may function as an output unit outputting information between the electronic device 100 and the user, and at the same time, function as an input unit providing an input interface between the electronic device 100 and the user.

As such, the processor 130 may receive an input for setting user preferences for each image through the display 110 including the touch panel. Specifically, the processor 130 may detect the user touch input on the display 110 on which the image is displayed while the image is displayed through the display 110.

In this case, when the user touch input is detected, the processor 130 may identify that the user preference for the image displayed through the display 110 is set. The processor 130 may identify a time for which the user touch input is maintained. Also, the processor 130 may identify a user preference value for an image displayed through the display 110 based on the time for which the user touch input is maintained. In this case, the processor 130 may identify a user preference value for an image displayed through the display 110 in proportion to a time for which the user touch input is maintained.

For example, referring to FIG. 9, while the image is displayed through the display 110, the processor 130 may receive the touch input from the user. Further, the processor 130 may display a graphic object 510 indicating that the user touch input is maintained through the display 110 while the user touch input is maintained.

The graphic object 510 also indicates that the user preference increases according to the user touch input. Through the graphic object 510, the user may recognize that the user preference for the image displayed through the display 110 increases as the touch input is maintained. For instance, as the user maintains the touch input, the graphic object 510 is consistently displayed. Additionally, as the touch duration increases, a greater number of visual indicators (such as heart icons) associated with the graphic object 510 progressively increase, reflecting the user's preference for the image. When the user touch input ends, the processor 130 may set a user preference for an image displayed through the display 110 based on the time for which the user touch input is maintained. In this way, the processor 130 may set user preferences for each image, and then select an image displayed on the graphic UI based on the user preferences.

Meanwhile, as the above-described method of inputting user preference, various methods such as a long press touch, a user touch count, and a drag input may be set. For example, in the case of the long press method, as described above, when the user touches a specific area of an image while the image is displayed on the display 110, the processor 130 may set the user preference for the image displayed on the display 110 to a value corresponding to the time for which the user touch input is maintained. Alternatively, in the case of the user touch count method, when the user repeatedly inputs a touch input through the display 110 while the image is displayed on the display 110, the processor may set the user preference for the image displayed on the display 110 to the value corresponding to the number of times of the user touch input. Alternatively, in the case of the drag method, when the user inputs a drag input through the display 110 while an image is displayed on the display 110, the processor 130 may set the user preference for the image displayed on the display 110 based on the range, direction, input time, and the like of the user drag input.

Meanwhile, the user touch input may be input by various electronic devices, such as an electronic pen, in addition to the user's finger (or the user's specific body).

In addition, the processor 130 may detect a user input of touching an image after pressing (or while pressing) a button (e.g., a button for executing an artificial intelligence function) provided in the electronic device 100. Alternatively, the processor 130 may detect a user input for selecting an image using a predefined action.

Meanwhile, the processor 130 may generate the calendar UI 10 in which an image selected based on the user preference is displayed as a thumbnail image in one date area. That is, the processor 130 may generate the thumbnail image by reducing the size of the selected image based on the user preference (or user preference and context information). The processor 130 may display the acquired thumbnail image in the date area. The selected image based on the user preference may be a representative image identified based on the user preference among the plurality of images when there are a plurality of selected images corresponding to the date area.

Referring back to FIG. 7, the processor 130 may reduce the size of the selected image (i.e., image acquired at 12:40) to generate the thumbnail image 21, and display the generated thumbnail image 21 in an area corresponding to July 8. This may also be applied to FIGS. 3, 4, 5, and 8 as well.

Meanwhile, when the plurality of images are selected on the same date, the processor 130 may further display, in the date area, a UI indicating the number of the plurality of images or that the plurality of images are selected together with the thumbnail image.

Through this, the user may intuitively identify an image acquired on each date or time using only the calendar UI 10. In particular, the reason why a user sets user preference for an image is to search for or use the corresponding image in the future. Accordingly, according to the disclosure, by displaying only the image for which the user preference is set on the calendar UI 10, the utilization of stored images may be further expanded.

Meanwhile, according to an embodiment of the disclosure, when the displayed thumbnail image is selected, the processor 130 may control the display 110 to display, on the calendar UI 10, a pop-up window having at least one of a first area displaying the selected image, a second area displaying a context included in the selected image, a third area displaying the searched other images, and a fourth area displaying remaining images other than the selected image from among the plurality of selected images.

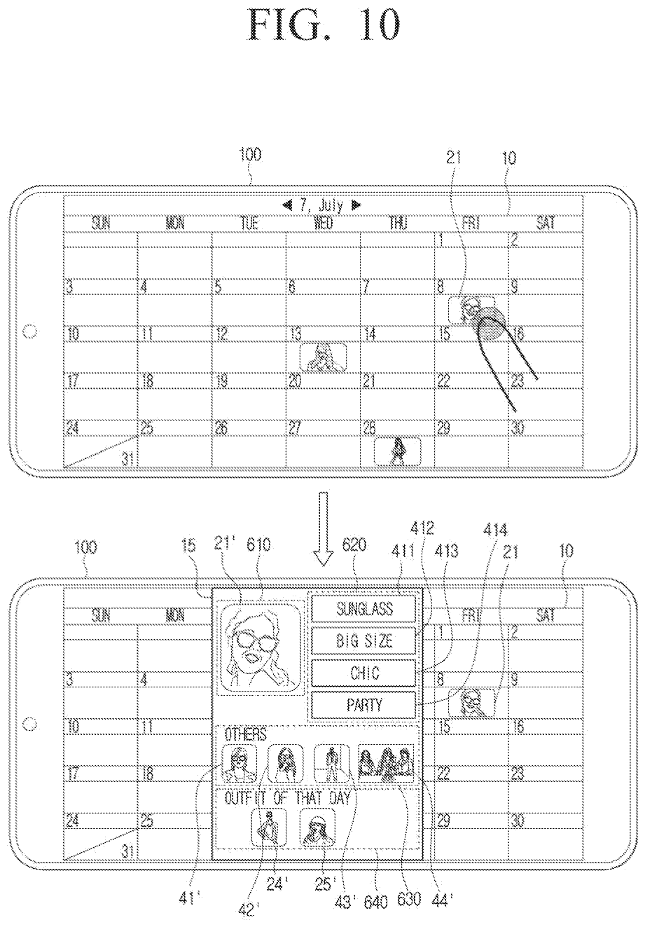

FIG. 10 is an exemplary diagram of a pop-up window displayed when a thumbnail image is selected according to an embodiment of the disclosure.

Specifically, when the processor 130 receives a user input for selecting a thumbnail image through an input interface or detects a touch input for selecting a thumbnail image through the display 110, the processor 130 may display the pop-up window on the calendar UI 10.

In this case, the pop-up window may include a plurality of areas (first to fourth areas). In this case, the sizes of each of the plurality of regions and each position within the pop-up window may be set so that each area is separated without overlapping.

Meanwhile, images and information displayed in each area may be different. Specifically, the selected image 21 may be displayed in the first area. That is, the thumbnail image 21 displayed in the date area may be displayed in the first area. In this case, a displayed image 21′ may be in the form of an enlarged thumbnail image. Further, the context information 411, 412, 413, and 414 of the selected thumbnail image may be displayed in the second area. Further, other images having context information corresponding to context information of the thumbnail image may be displayed in the third area. That is, thumbnail images and related images 41′, 42′, 43′, and 44′ may be displayed in the third area. In addition, the remaining images 24′ and 25′ other than the selected image as the thumbnail image among the plurality of images selected corresponding to the date area may be displayed in the fourth area. That is, the remaining images 24′ and 25′ acquired on the date corresponding to the date area may be displayed in the fourth area.

In this case, according to an embodiment of the disclosure, when there are a plurality of searched other images, the processor 130 may determine an arrangement position of each other image in the third area based on the user preference set for each other image.

In detail, the processor 130 may use user preferences for related images to arrange related images acquired based on the image (or thumbnail image) selected by the user and the context information in the third area of the pop-up window.

In detail, when there are a plurality of related images, the processor 130 may identify user preferences for the plurality of related images, respectively, and arrange the related images in the third area in the order of the highest user preference.

For example, referring to FIG. 10, the processor 130 may identify user preferences of three related images 41′, 42′, 43′, and 44′, respectively, and arrange the image 41 having the highest user preference in a first order (or leftmost) in the third area. The processor 130 may arrange the remaining related images 42′, 43′, and 44′ in the third area in order of the user preference.

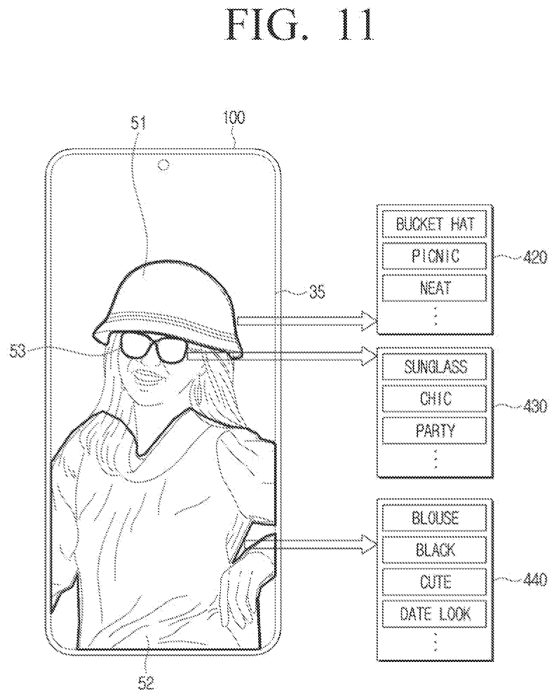

FIG. 11 is an exemplary diagram illustrating identification of a context of an object included in a selected image according to an embodiment of the disclosure.

Meanwhile, as an embodiment of the disclosure, the processor 130 identifies at least one object included in the selected image, checks a context of the identified object, and searches for other images having a context corresponding to the identified context.

Specifically, first, the processor 130 may identify an object included in an image selected by a user. To this end, the processor 130 may use a neural network model trained to identify objects in images stored in the memory 120. The processor 130 may input an original image of the image displayed in the date area to the neural network model and acquire an object recognition result included in the original image. In this case, the object recognition result may include object type information. Meanwhile, for convenience of description of the disclosure, a neural network model trained to identify an object in an image will be referred to as a third neural network model. The third neural network model may be a neural network model trained based on training data composed of a plurality of images including objects and object information in each image.

Meanwhile, the processor 130 may check the context of the identified object. Specifically, the processor 130 may acquire context information of an object based on a matching table of each object information and context information. For example, the memory 120 may store a matching table regarding context information matched with each entity type. Accordingly, the processor 130 may identify an object type corresponding to object information in the identified image in the matching table and check context information matching the identified object type.

For example, referring to FIG. 11, the processor 130 may identify objects 51, 52, and 53 in the selected image. In this case, as described above, the processor 130 may input the selected image to the third neural network model to identify an object in the selected image. In this case, the processor 130 identifies an object in the selected image 35 as a bucket hat 51, sunglasses 53, and a blouse 52. Further, the processor 130 may acquire context information 420 matched with the bucket hat 51, context information 430 matched with the sunglasses 53, and context information 440 matched with the blouse 52, respectively, according to the matching table (object-context matching table).

Meanwhile, in this case, the context information of each object may include object information. That is, context information theory related to the bucket hat 51, “bucket hat”, “Picnic”, “knit”, etc., may be acquired.

In this case, according to an embodiment of the disclosure, when a plurality of objects included in the selected image are identified, the processor 130 may select one object from among the plurality of identified objects based on user preference, check the context of the selected object, and search for other images with a context corresponding to the checked context.

Specifically, the processor 130 may identify user preferences set for a plurality of objects included in the selected image, respectively. That is, the user preferences may be set not only for images, but also for objects included in images. As such, the processor 130 may identify a storage purpose, subject, and the like of the image based on a type of objects for which the user preference is set in the image.

Meanwhile, the processor 130 may identify user preferences for a plurality of objects included in the selected image and then select one object based on the identified user preferences. In this case, the processor 130 may identify an object having the highest user preference as an object corresponding to the selected image.

In addition, the processor 130 may check the context of the one selected object and search for other images having a context corresponding to the checked context. Specifically, the processor 130 may search for an image related to the selected image based on the context of one object selected based on the user preference. That is, as described above, the processor 130 may use context information of an object included in an image to search for the related image. When the plurality of objects are included in an image, the related image may be searched using only the context information of the object selected by the user preference.

Also, according to an embodiment of the disclosure, the user preference set for the image may be identified as the sum of user preferences set for a plurality of objects included in the image. For example, referring to FIG. 11, when user preferences are each set to 31, 35, and 56 for each of the plurality of objects (bucket hat, sunglasses, and blouse) included in the image 35, the user preferences set for the images may be identified as 122 (31+35+56). In addition, the processor 130 may search for a related image based on the context (blouse, black, cute, date look, etc.) of the object (blouse) for which the user preference is 56.

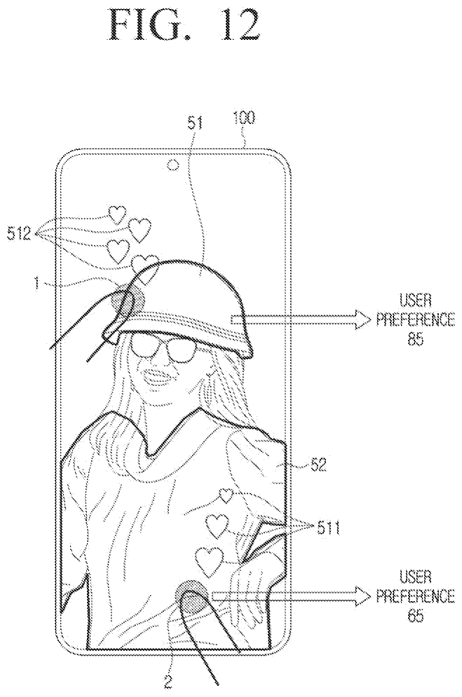

FIG. 12 is an exemplary diagram illustrating setting user preference to an object included in an image according to an embodiment of the disclosure.

Meanwhile, the processor 130 may recognize an object included in an image based on the user touch input for the image. That is, according to an embodiment of the disclosure, the processor 130 may identify the touch area detected through the display 110 on the selected image and identify the object included in the touch area. Specifically, the processor 130 may detect a long press touch in which a point of an object is touched for a preset time period.

Also, the processor 130 may detect an object area where an object is displayed through image analysis based on information on a point where the user touch input is detected. Also, the processor 130 may identify an object based on an image (i.e., an image including an object) corresponding to the detected object area.

For example, the processor 130 may crop an image corresponding to the detected object region and input the cropped image to a third neural network model to identify the type of object.

Referring to FIG. 12, the processor 130 may identify the type of objects only for objects included in the area where the user touch input is detected. Accordingly, comparing FIG. 11 and FIG. 12, in FIG. 12, the type of objects may be identified only for the bucket hat and blouse for which the user touch is detected.

Meanwhile, according to an embodiment of the disclosure, an object to be executed as an object type in an image may be selected by various methods other than a touch input. For example, the processor 130 may detect a user input of multi-touching or strongly touching an object using a finger, an electronic pen, or the like, drawing around the object or diagonally dragging an object through at least a part of the object, and identify an object in the image based on the detected user input. Alternatively, the electronic device 100 may detect a user input of touching an object after pressing (or while pressing) a button (e.g., a button for executing an artificial intelligence function) provided in the electronic device 100. Alternatively, the electronic device 100 may detect a user input for selecting an object using a predefined action.

Meanwhile, the processor 130 may also set the user preference for the object included in an image based on the user touch input. In this regard, the method of inputting user preference described with reference to FIG. 9 may be equally applied.

Referring to FIG. 12, the processor 130 may detect a user touch input 1 for the bucket hat and identify a user preference for the bucket hat based on the time for which the detected touch input 1 is maintained. Also, the processor 130 may detect a user touch input 2 for the blouse and identify a user preference for the blouse based on the time for which the detected touch input 2 is maintained. The user preferences for the hat and the blouse are indicated using a first set of graphic objects 511 and a second set of graphic objects 512. For instance, as the duration of touch input 1 and touch input 2 extends, the number of the first set of graphic objects 511 and the number of the second set of graphic objects 512 may each increase, respectively. FIG. 11 illustrates that the processor 130 identifies user preference for a bucket hat as 85 and user preference for a blouse as 65 based on a user touch input for each object 51 and 52 and a holding time of the touch input.

Meanwhile, user preference for an image and user preference for an object included in the image may be classified according to whether the object is included in the area of the user touch input. For example, the processor 130 identifies that the user preference for the image is input when the object within the region corresponding to the user touch input is not included, and may identify that the user preference for the object included in the image is input when the object within the area corresponding to the user touch input is included.

However, it is not limited thereto, and the user preference for the image may be identified as the sum of user preferences for objects included in the image.

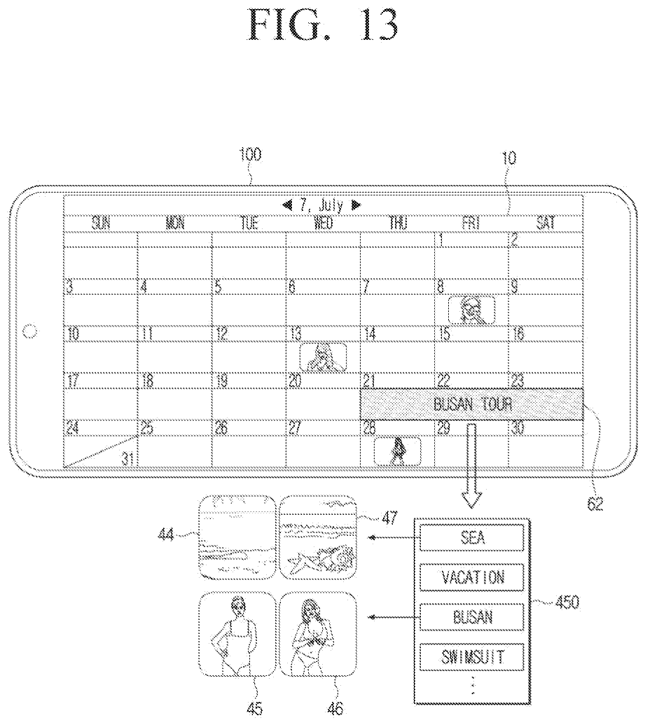

FIG. 13 is an exemplary diagram illustrating acquiring an image having a context corresponding to a user schedule according to an embodiment of the disclosure.

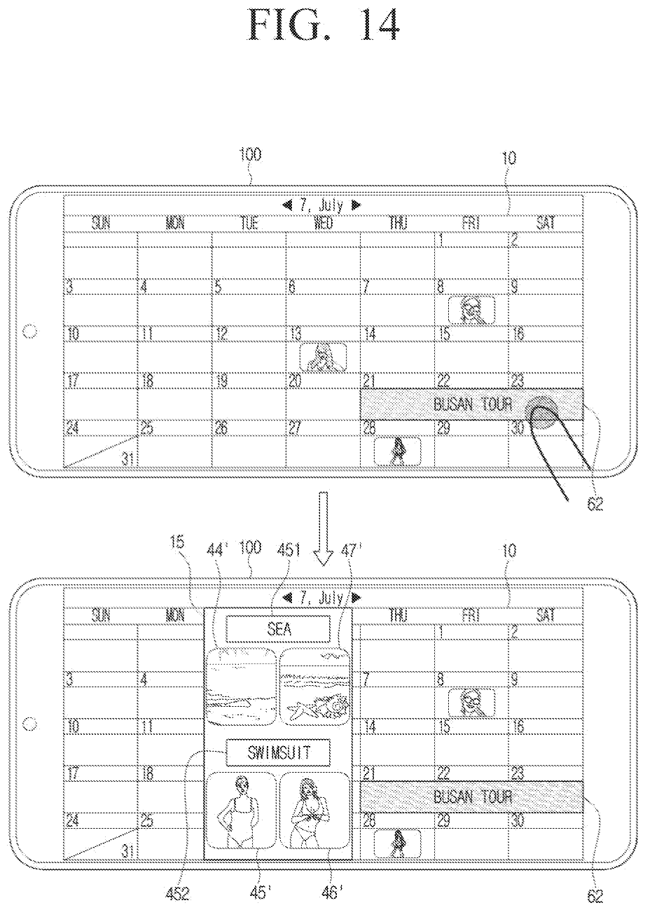

FIG. 14 is an exemplary diagram illustrating displaying an image having a context corresponding to a user schedule according to an embodiment of the disclosure.

Meanwhile, according to an embodiment of the disclosure, the processor 130 may check a user schedule and generate the calendar UI 10 displaying an image having a context corresponding to the user schedule among a plurality of images.

The processor 130 may check a user schedule set on the calendar UI 10 and acquire context information corresponding to the checked user schedule. Specifically, the processor 130 may acquire context information on the time, location, place, and the like of the user schedule set on the calendar UI 10.

To this end, the processor 130 may analyze text related to a user schedule set on the calendar UI 10 and acquire context information based on the analysis result. In this case, the processor 130 may acquire context information on the user schedule by using a neural network model trained to output context information by analyzing text pre-stored in the memory 120. Hereinafter, for convenience of description of the disclosure, a neural network model trained to analyze text to acquire context information will be referred to as a fourth neural network model. Specifically, the processor 130 may acquire the context information on the user schedule by inputting text about the user schedule to the fourth neural network model.

For example, referring to FIG. 14, the processor 130 may identify “Busan tour” set for July 21 to July 23 on the calendar UI 10 as the user schedule 62. In addition, the processor 130 may acquire “Sea”, “Vacation”, “Busan”, and “Swimsuit” as context information on “Busan tour” corresponding to the identified user schedule 62. As described above, the processor 130 may acquire the context information by inputting the text of “Busan tour” to the fourth neural network model pre-stored in the memory 120.

Alternatively, the processor 130 may acquire keyword information, tagging information, and the like input in relation to the user schedule 62 as context information of the user schedule 62.

The processor 130 may acquire context information on the acquired user schedule 62 and an image having corresponding context information from the memory 120.

Specifically, the processor 130 may identify context information corresponding to the context information on the user schedule 62 based on a matching table related to context information pre-stored in the memory 120. Here, the context information corresponding to the context information on the user schedule 62 may include the same context information as the context information on the user schedule 62 and related context information.

The processor 130 may acquire an image stored in the memory 120 by matching the identified context information after identifying the context information corresponding to the context information on the user schedule 62. Referring to FIG. 13, the processor 130 may acquire two images 44 and 47 having context information corresponding to “sea” among the context information of “Busan tour” and acquire two images 45 and 46 having context information corresponding to “swimsuit”.

As such, the processor 130 may acquire an image related to the user schedule 62 set on the calendar UI 10 from among the plurality of images stored in the memory 120.

The processor 130 may display an image having context information corresponding to the acquired user schedule 62 on the calendar UI 10. Specifically, when receiving the user input for selecting the user schedule 62 displayed on the calendar UI 10, the processor 130 may display the image acquired based on the context information on the calendar UI 10.

For example, referring to FIG. 14, the processor 130 may detect the user touch input selecting the user schedule 62 set on the calendar UI 10 through the display 110. Then, the processor 130 may generate a pop-up window for displaying the context information of the user schedule 62 and the images 44, 45, 46, and 47 having the context information corresponding to the context information of the user schedule 62, and display the generated pop-up window on the calendar UI 10. In this case, images having context information each corresponding to the context information of the user schedule 62 may be separately displayed on the pop-up window.

Specifically, the processor 130 may display the two images 44′ and 47′ having a context corresponding to “sea” 451 among context information of “Busan tour” corresponding to the user schedule 62 in a fifth area together with “sea” as the context information. Two images 45′ and 46′ having contexts corresponding to “swimsuit” 452 among the context information of “Busan tour” may be displayed in a sixth area together with the context information “swimsuit”. In this case, the context information for which an image is not acquired may not be displayed on the pop-up window.

Meanwhile, the processor 130 may acquire an image based only on a preset type of context information among a plurality of pieces of context information of the user schedule 62. For example, a plurality of pieces of context information may be classified into types such as place, time, clothing, and situation. For example, referring to FIG. 13, among a plurality of pieces of context information, “sea” and “Busan” may be classified as places, “swimwear” may be classified as clothing, and “vacation” may be classified as situations. In this case, the process may acquire an image using only a context corresponding to clothing among a plurality of contexts. That is, the processor 130 may acquire only an image having a context corresponding to “swimsuit” corresponding to clothing from the memory 120. The processor 130 may display an image having a context corresponding to the acquired “swimsuit” on the calendar UI 10.

Accordingly, a user may receive information on clothing, coordinating, etc., related to the user schedule 62.

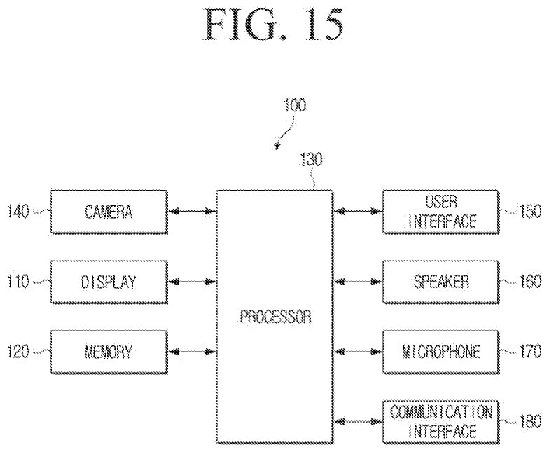

FIG. 15 is a detailed configuration diagram of an electronic device according to an embodiment of the disclosure.

An electronic device according to an embodiment of the disclosure illustrated in FIG. 15 includes a display 110, a memory 120, a camera 140, a user interface 150, a speaker 160, a microphone 170, a communication interface 180, and a processor 130. A detailed description for components overlapped with components illustrated in FIG. 2 among components illustrated in FIG. 15 will be omitted.

The camera 140 is a component that acquires an image. Specifically, the camera 140 may acquire an image related to an object based on a user input. To this end, the camera may be implemented as an imaging device such as a CMOS image sensor (CIS) having a CMOS structure, a charge coupled device (CCD) having a CCD structure, or the like. However, the camera is not limited thereto, and the camera may be implemented as a camera module of various resolutions capable of capturing a subject.

The user interface 150 may be implemented as a device such as a button, a touch pad, a mouse, and a keyboard, or may be implemented as a touch screen, a remote control transceiver, and the like capable of performing the above-described display function and manipulation input function together. The remote control transceiver may receive a remote control signal from an external remote control device or transmit a remote control signal through at least one of infrared communication, Bluetooth communication, and Wi-Fi communication.

The speaker 160 may output a sound signal to the outside of an electronic device 100′. The speaker 160 may output multimedia reproduction, recording reproduction, various kinds of notification sounds, voice messages, and the like. The electronic device 100 may include an audio output device such as a speaker 160, or may include an output device such as an audio output terminal. In particular, the speaker 160 may provide acquired information, information processed/produced based on the acquired information, a response result to a user's voice, an operation result, or the like in the form of voice. For example, the speaker 160 may output the context information of the selected image, the date, and the like in the form of voice.

The microphone 170 may refer to a module that acquires sound and converts the acquired sound into an electrical signal, and may be a condenser microphone, a ribbon microphone, a moving coil microphone, a piezoelectric element microphone, a carbon microphone, or a micro electro mechanical system (MEMS) microphone. In addition, it may be implemented in non-directional, bi-directional, unidirectional, sub-cardioid, super-cardioid, and hyper-cardioid methods.

The communication interface 180 may input and output various types of data. For example, the electronic device 100 may store an acquired image in an external server or acquire the stored image through the communication interface 180. To this end, the communication interface 180 may transmit and receive various types of data to and from an external device (e.g., source device), an external storage medium (e.g., USB memory), an external server (e.g., web hard), etc., through communication methods such as AP-based Wi-Fi (wireless LAN network), Bluetooth, Zigbee, a wired/wireless local area network (LAN), a wide area network (WAN), Ethernet, IEEE 1394, a high-definition multimedia interface (HDMI), a universal serial bus (UBS), a mobile high-definition link (MHL), an audio engineering society/European broadcasting union (AES/EBU), optical, and coaxial.

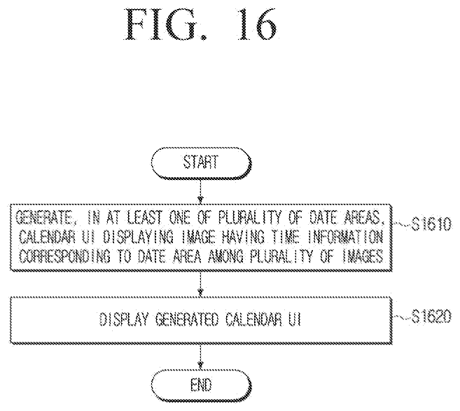

FIG. 16 is a schematic flow chart illustrating a method of controlling an electronic device according to an embodiment of the disclosure.

Referring to FIG. 16, the processor 130 generates the calendar UI 10 displaying an image having time information corresponding to a date area among a plurality of images in at least one of a plurality of date areas (operation S1610), and displays the generated calendar UI 10 (operation S1620).

In this case, according to an embodiment of the disclosure, the processor 130 may select the plurality of images based on user preference set for each of the plurality of images and generate the calendar UI displaying an image having time information corresponding to the date area among the plurality of selected images. Specifically, the processor 130 may receive user preferences for images based on a user touch input, a drag input, and the like, and then set user preferences for each image. In this case, in order to select the image displayed on the calendar UI 10, the processor 130 may select only an image for which user preference is set among a plurality of images stored in the memory 120 and then display the image on the calendar UI 10.

In this case, when a plurality of images having time information corresponding to a date area are selected, the processor 130 may select one image from among the plurality of selected images based on user preference, and generate a calendar UI displaying the selected image.

Specifically, when a plurality of images for which user preference is set are selected for a specific date, the processor 130 may select an image having the highest user preference among the plurality of images for which user preferences are set. That is, the processor 130 may set the image having the highest user preference as the representative image of the corresponding date. The processor 130 may display the selected image on the calendar UI.

Meanwhile, the user preference may be set based on the input time of the touch input on each image detected through the display 110 including the touch panel.

According to an embodiment of the disclosure, the processor 130 may generate the calendar UI in which an image selected based on the user preference is displayed as a thumbnail image in one date area. In this case, when the thumbnail image displayed on the calendar UI is selected, the processor may control the display to display, on the calendar UI, a pop-up window having at least one of a first area displaying the selected image, a second area displaying a context included in the selected image, a third area displaying the searched other images, and a fourth area displaying remaining images other than the selected image from among the plurality of selected images.

Specifically, the processor 130 may generate a pop-up window for displaying an image selected by a user, context information included in the selected image, searched other images, and other images acquired on the same date as the selected image. In this case, the pop-up window may include a plurality of areas (first to fourth areas). In this case, the sizes of each of the plurality of regions and each position within the pop-up window may be set so that each area is separated without overlapping.

In this case, when there are a plurality of searched other images, the processor 130 may determine an arrangement positions of each other image in the third area based on the user preference set for each other image. Specifically, the processor 130 may identify user preferences set for each of the plurality of searched different images, and arrange the plurality of searched images in the order of highest user preference in the third area within the pop-up window.

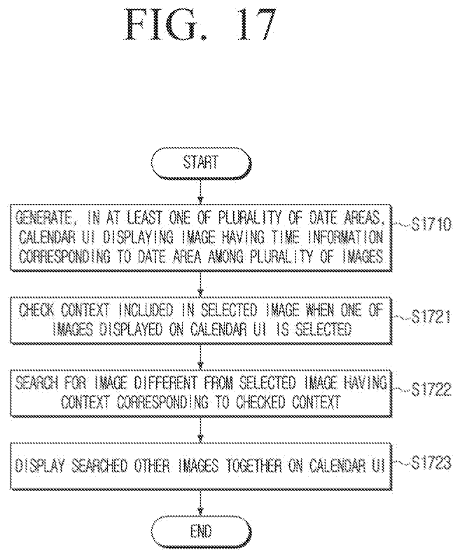

FIG. 17 is a schematic flowchart of a method of controlling an electronic device that searches for a related image based on context information, according to an embodiment of the disclosure.

Operation S1710 illustrated in FIG. 17 may correspond to operation S1610 described in FIG. 16. Therefore, a detailed description thereof will be omitted.

Referring to FIG. 17, when one of the images displayed on the calendar UI is selected, the processor 130 may check the context included in the selected image (operation S1721), and search for an image different from the selected image having a context corresponding to the checked context (operation S1722). The processor 130 also displays the searched other images together on the calendar UI (operation S1723).

Meanwhile, according to an embodiment of the disclosure, after checking the context included in the selected image (operation S1721), the processor 130 may search for other images having the checked context within a preset date range based on the date corresponding to the selected image.

In this case, the processor may select only a context related to the user schedule from among a plurality of contexts included in the selected image. Specifically, the processor 130 may check a user schedule set in a date area corresponding to the selected image, and check a context corresponding to the user schedule among the contexts included in the selected image. Also, the processor 130 may search for other images having a context corresponding to the checked context.

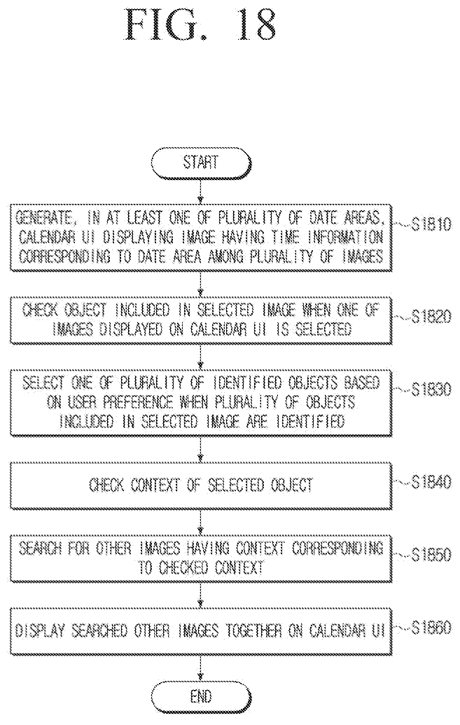

FIG. 18 is a schematic flowchart of a method of controlling an electronic device that searches for a related image based on context information of an object included in a selected image, according to an embodiment of the disclosure.

Operation S1810 illustrated in FIG. 18 may correspond to operation S1610 described in FIG. 16 and may correspond to S1710 in FIG. 17. In addition, operation S1860 illustrated in FIG. 18 may correspond to operation S1620 described in FIG. 16 and may correspond to operation S1723 illustrated in FIG. 17. Therefore, a detailed description thereof will be omitted.

Meanwhile, according to an embodiment of the disclosure, when one image is selected by the user (or by user input) among images displayed on the calendar UI, the processor 130 may identify at least one object included in the selected image (operation 1820). In addition, the processor 130 may check the context of the identified object and search for other images having a context corresponding to the checked context.

Specifically, first, the processor 130 may identify an object included in an image selected by a user. To this end, the processor 130 may use the third neural network model trained to identify objects in images stored in the memory 120. The processor 130 may input an original image of the image displayed in the date area to the third neural network model and acquire the object recognition result included in the original image. In this case, the object recognition result may include object type information.

The processor 130 may check the context of the identified object. Specifically, the processor 130 may acquire context information of an object based on a matching table of each object information and context information.

Also, the processor 130 may search for other images having a context corresponding to the context of the acquired object.

Meanwhile, referring to FIG. 18, according to an embodiment of the disclosure, when a plurality of objects included in the selected image are identified, the processor may select one object from among the plurality of identified objects based on the user preference (operation S1830) and check the context of the selected object (operation S1840). Also, the processor 130 may search for other images having a context corresponding to the checked context (operation S1860).

Specifically, the processor 130 may identify user preferences set for a plurality of objects included in the selected image, respectively. That is, the user preferences may be set not only for images, but also for objects included in images.

The processor 130 may identify user preferences for a plurality of objects included in the selected image and then select one object based on the identified user preferences. In this case, the processor 130 may identify an object having the highest user preference as an object corresponding to the selected image. In addition, the processor 130 may check the context of the one selected object and search for other images having a context corresponding to the checked context.

Meanwhile, in the above description, operations S1610 to S1620, S1710 to S1723, and S1810 to S1860 may be further divided into additional steps or combined into fewer steps according to an implementation example of the disclosure. Also, some steps may be omitted if necessary, and an order between the steps may be changed. In addition, even if other contents are omitted, the description of the embodiment of the electronic device described in FIGS. 1 to 15 may be equally applied to the above-described method of controlling the electronic device.

Meanwhile, according to an embodiment of the disclosure, various embodiments described above may be implemented by software including instructions stored in a machine-readable storage medium (for example, a computer). A machine is a device capable of calling a stored instruction from a storage medium and operating according to the called instruction, and may include the electronic device of the disclosed embodiments. In the case in which a command is executed by the processor, the processor may directly perform a function corresponding to the command or other components may perform the function corresponding to the command under a control of the processor. The command may include codes generated or executed by a compiler or an interpreter. The machine-readable storage medium may be provided in a form of a non-transitory storage medium. Here, the term “non-transitory” means that the storage medium is tangible without including a signal, and does not distinguish whether data are semi-permanently or temporarily stored in the storage medium.

In addition, according to an embodiment, the above-described methods according to the diverse embodiments may be included and provided in a computer program product. The computer program product may be traded as a product between a seller and a purchaser. The computer program product may be distributed in a form of a storage medium (for example, a compact disc read only memory (CD-ROM)) that may be read by the machine or online through an application store (for example, PlayStore™). In case of the online distribution, at least a portion of the computer program product may be at least temporarily stored in a storage medium such as a memory of a server of a manufacturer, a server of an application store, or a relay server or be temporarily generated.

In addition, each of components (for example, modules or programs) according to various embodiments described above may include a single entity or a plurality of entities, and some of the corresponding sub-components described above may be omitted or other sub-components may be further included in the diverse embodiments. For example, the term “a processor” may refer to either a single processor or multiple processors. When a processor is described as carrying out an operation and the processor is referred to perform an additional operation, the multiple operations may be executed by either a single processor or any one or a combination of multiple processors. Alternatively or additionally, some components (e.g., modules or programs) may be integrated into one entity and perform the same or similar functions performed by each corresponding component prior to integration. Operations performed by the modules, the programs, or the other components according to the diverse embodiments may be executed in a sequential manner, a parallel manner, an iterative manner, or a heuristic manner, at least some of the operations may be performed in a different order or be omitted, or other operations may be added.

Although exemplary embodiments of the disclosure have been illustrated and described hereinabove, the disclosure is not limited to the abovementioned specific exemplary embodiments, but may be variously modified by those skilled in the art to which the disclosure pertains without departing from the gist of the disclosure as disclosed in the accompanying claims. These modifications should also be understood to fall within the scope and spirit of the disclosure.

What is claimed is:

1. An electronic device, comprising:
a display;
a memory configured to store one or more instructions; and
a processor configured to:
control the display, in a date area of the calendar UI, to display a first image having time information corresponding to the date area, among a plurality of images, and
based on the first image being selected among the plurality of images, identify a context included in the first image, search for a second image that is different from the first image and corresponds to the identified context, and control the calendar UI to display the second image together with the first image on the calendar UI.

2. The electronic device of claim 1, wherein the processor is further configured to search for the second image having the identified context within a preset date range based on a date corresponding to the first image.

3. The electronic device of claim 1, wherein the processor is further configured to identify the context corresponding to a user schedule, among a plurality of contexts included in the first image, and search for the second image having the identified context.

4. The electronic device of claim 1, wherein the processor is further configured to select the second image among the plurality of images, based on user preference that is set for each of the plurality of images.

5. The electronic device of claim 4, wherein based on two or more images having the time information corresponding to the date area being selected among the plurality of images, the processor is further configured to select one of the two or more images as the first image, based on the user preference.

6. The electronic device of claim 5, wherein the processor is further configured to control the display to display the first image as a thumbnail image of the first image in the date area of the calendar UI.

7. The electronic device of claim 6, wherein:
based on the thumbnail image being selected from the calendar UI, the processor is further configured to control the display to display a pop-up window having at least one of a first area displaying the first image, a second area displaying the context included in the first image, a third area displaying the searched other images, and a fourth area displaying remaining images other than the first image from among the plurality of images.

8. The electronic device of claim 7, wherein the processor is further configured to determine an arrangement position of each of the other images in the third area based on user preference set for each of the other images.

9. The electronic device of claim 4, further comprising a display configured to receive a touch input,
wherein the user preference is set based on a time duration of the touch input on each of the plurality of images.

10. The electronic device of claim 1, wherein the processor is further configured to:
identify an object included in the first image, and identify a context of the object as the context of the first image.

11. The electronic device of claim 1, wherein the processor is further configured to:
identify a plurality of objects included in the first image, select an object from among the plurality of objects based on user preference, identify the context of the first object as the context of the first image.

12. A method of controlling an electronic device, the method comprising:
controlling a display, in a date area of the calendar UI, to display a first image having time information corresponding to the date area, among a plurality of images; and
based on the first image being selected among the plurality of images, identifying a context included in the first image;
searching for a second image that is different from the first image and corresponds to the identified context; and
displaying the first image and the second image together on the calendar UI.

13. The method of controlling the electronic device of claim 12, wherein the searching for the second image comprises:
searching for the second image within a preset date range based on a date corresponding to the selected image.

14. The method of controlling the electronic device of claim 12, further comprising:
identifying the context corresponding to a user schedule, among a plurality of contexts included in the first image, and searching for the second image having the identified context.

15. The method of controlling the electronic device of claim 12, further comprising:
selecting the second image among the plurality of images, based on user preference that is set for each of the plurality of images.

16. The method of controlling the electronic device of claim 12, further comprising:
based on two or more images having the time information corresponding to the date area being selected among the plurality of images, selecting one of the two or more images as the first image, based on the user preference.

17. The method of controlling the electronic device of claim 16, wherein the controlling of the display comprises:
controlling the display to display the first image as a thumbnail image of the first image in the date area of the calendar UI.

18. A non-transitory computer readable recording medium including a program executes a controlling method of a electronic device, the method comprising:
controlling a display to display, in a date area of the calendar UI, a first image having time information corresponding to the date area, among a plurality of images; and
based on the first image being selected among the plurality of images, identifying a context included in the first image;
searching for a second image that is different from the first image and corresponds to the identified context; and
displaying the first image and the second image together on the calendar UI.

19. The non-transitory computer readable recording medium of claim 18, wherein the searching for the second image comprises:
searching for the second image within a preset date range based on a date corresponding to the selected image.

20. The non-transitory computer readable recording medium of claim 18, wherein the method further comprising:
identifying the context corresponding to a user schedule, among a plurality of contexts included in the first image, and searching for the second image having the identified context.
